(19) United States
(12) Patent Application Publication
(10) Pub. No.: US 2023/0238533 A1
(43) Pub. Date: Jul. 27, 2023

(54) NEGATIVE ACTIVE MATERIAL FOR ALL SOLID-STATE BATTERY

(71) Applicant: SAMSUNG SDI CO., LTD., Yongin-si (KR)

(72) Inventors: Hyuksoo SHIN, Yongin-si (KR); Sunghyun NOH, Yongin-si (KR); Sangil HAN, Yongin-si (KR); Jinkyu KIM, Yongin-si (KR); Jinhoon YANG, Yongin-si (KR); Byeonggyu CHO, Yongin-si (KR)

(21) Appl. No.: 18/098,165

(22) Filed: Jan. 18, 2023

(30) Foreign Application Priority Data
Jan. 27, 2022 (KR) 10-2022-0012705

(51) Int. Cl. H01M 4/587; H01M 10/0562; H01M 4/38

(52) U.S. Cl. CPC H01M 4/587; H01M 10/0562; H01M 4/382; H01M 2004/027

(57) ABSTRACT

A negative active material for an all solid-state includes an aggregated material of amorphous carbon having pores therein in which primary particles are aggregated, and metal nanoparticles filling in the pores.

### CROSS-REFERENCE TO RELATED APPLICATION

This application claims priority to and the benefit of Korean Patent Application No. 10-2022-0012705 filed in the Korean Intellectual Property Office on Jan. 27, 2022, the entire contents of which are incorporated herein by reference.

### BACKGROUND OF THE INVENTION

### 1. Field

Embodiments relate to a negative active material for an all solid-state battery.

### 2. Description of the Related Art

Recently, with the rapid spread of electronic devices such as mobile phones, laptop computers, and electric vehicles using batteries, the demand for small, lightweight, and relatively high-capacity rechargeable batteries has been rapidly increasing. Particularly, a rechargeable lithium battery has recently drawn attention as a driving power source for portable devices, due to its lighter weight and high energy density. Accordingly, research for improving the performance of rechargeable lithium batteries is being actively studied.

Among rechargeable lithium batteries, the term “all solid-state battery” refers to a battery in which all materials are solid, and particularly, refers to a battery using a solid electrolyte.

### SUMMARY

Embodiments are directed to a negative active material for an all solid-state battery, the negative active material including an aggregated material of amorphous carbon having pores inside and in which primary particles are aggregated; and metal nanoparticles filling in the pores

An embodiment may provide a negative active material for an all solid-state battery exhibiting excellent cycle-life characteristics and power characteristics.

An embodiment may provide an all solid-state battery including the negative active material.

An embodiment may provide a negative active material for an all solid-state battery including an aggregated material of amorphous carbon having pores inside and in which primary particles are aggregated; and metal nanoparticles filled in the pores.

The metal nanoparticle may be Ag, Au, Sn, Zn, Al, Mg, Ge, Cu, In, Ni, Bi, Pt, Pd, or a combination thereof.

The metal nanoparticles may have an average size of about 5 nm to about 80 nm.

A mixing ratio of the aggregated material of amorphous carbon and the metal nanoparticles may be about 99:1 to 70:30 by weight ratio, or about 99:1 to 75:25 by weight ratio.

The amorphous carbon may be, for example, carbon black, acetylene black, denka black, ketjen black, furnace black, activated carbon, or a combination thereof.

The negative active material may be an active material prepared by mixing an aggregated material of amorphous carbon having pores inside and in which primary particles are aggregated, with metal nanoparticles, to prepare a mixture, and heat-treating the mixture at a temperature of the melting point of the metal nanoparticles or at a greater temperature.

Another embodiment may provide an all solid-state battery including: a negative electrode including a current collector and a negative electrode layer on one side of the current collector; a positive electrode; and a solid electrolyte between the negative electrode and the positive electrode, wherein the negative electrode layer includes the negative active material.

The solid electrolyte may be a sulfide solid electrolyte.

The solid electrolyte may be LiₐM_{b}P_{c}S_{d}Aₑ(where a, b, c, d, and e are all 0 or more and 12 or less, M is Ge, Sn, Si, or a combination thereof, and A is one of F, Cl, Br, or I).

The negative electrode may further include a lithium deposition layer that is present after charging. The lithium deposition layer may have a thickness of about 10 μm to about 50 μm.

The negative active material for an all solid-state battery according to an embodiment may exhibit excellent cycle-life characteristic and power characteristics.

### BRIEF DESCRIPTION OF THE DRAWINGS

Features will be apparent to those of skill in the art by describing in detail exemplary embodiments with reference to the attached drawings in which:

FIG. 1 is a drawing showing a preparation of the negative active material for an all solid-state battery according to an embodiment.

FIG. 2 is a schematic diagram illustrating charge and discharge states of the all solid-state battery according to an embodiment.

FIG. 3 shows SEM images of the negative active materials of Example 1 and Comparative Example 1.

FIG. 4 is a graph showing the cycle-life characteristics and coulomb efficiency of the all solid-state battery according to Example 1 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Unless otherwise defined in the specification, it will be understood that when an element, such as a layer, a film, a region, a plate, and the like is referred to as being “on” or “over” another element, it may be directly on, connected to, or coupled to the other element or layer, or one or more intervening elements may be present. In addition, it will also be understood that when an element is referred to as being “between” two elements, it may be the only element between the two elements, or one or more intervening elements may also be present.

Herein, the term “particle size” or “a particle diameter”, may refer to an average particle diameter. Unless otherwise defined in the specification, the average particle diameter may be defined as an average particle diameter D50 indicating the diameter of particles having a cumulative volume of 50 volume % in the particle size distribution, as may be measured by a PSA (particle size analyzer). The average particle size (D50) may be measured by, for example, electron microscope observation, such as by using a scanning electron microscopic (SEM), field emission scanning electron microscopy (FE-SEM), or a laser diffraction method, as examples. The laser diffraction method may be carried out by distributing particles to be measured in a distribution solvent and introducing the distributed product to a commercially available laser diffraction particle measuring device (e.g., MT 3000 available from Microtrac, Ltd.), irradiating ultrasonic waves of about 28 kHz at a power of 60 W, and calculating an average particle diameter (D50) in the 50% standard of particle distribution in the measuring device.

The average particle diameter (D50) of the nanoparticles may be measured by dynamic light scattering (DLS). The method may be performed according to ISO 22412. A mean particle size result of polydisperse samples is determined by peak analysis of the particle size distribution graph. The median D50 is the value separating the higher half of the data from the lower half. It is the determined particle size from which half of the particles are smaller and half are larger. According to the IUPAC definition, the equivalent diameter of a non-spherical particle is equal to a diameter of a spherical particle that exhibits identical properties to that of the investigated non-spherical particle.

A negative active material for an all solid-state battery according to an embodiment may include an aggregated material of amorphous carbon, in which primary particles are aggregated, and metal nanoparticles. In the negative active material according to an embodiment, the aggregated material of amorphous carbon may have pores inside the aggregated material of amorphous carbon (e.g., interior pores), and the pores may be filled with the metal nanoparticles. For example, the negative active material may include an aggregated material of an amorphous carbon including pores therein and metal nanoparticles positioned in the pores, and the aggregated material where primary particles of the amorphous carbon are aggregated.

The filling of the pores inside the aggregated material of amorphous carbon with the metal nanoparticles may allow the maintaining of a stable interface of the carbon-based aggregated material and metal nanoparticles, thereby improving power characteristics. Furthermore, the metal nanoparticles may fill the pores inside the carbon aggregated material. Thus, physical movement of the metal may be suppressed during repeated charging and discharging, thereby improving the cycle-life characteristics.

The metal of the metal nanoparticles may include, e.g., Ag, Au, Sn, Zn, Al, Mg, Ge, Cu, In, Ni, Bi, Pt, Pd, or a combination thereof. The inclusion of the metal nanoparticles in the negative active material may help further improve the electrical conductivity of the negative electrode.

A size of the metal nanoparticles, e.g., an average size of the metal nanoparticles, may be about 5 nm to about 80 nm. The metal nanoparticles may be appropriately used when the size is nanometers. When metal nanoparticles within a nanosize range are used, the battery characteristics, e.g., the cycle-life characteristics of the all solid-state battery, may be improved. If the size of the metal particles were to be increased to be in a range of micrometer units, the uniformity of the metal particles in the negative electrode layer may be reduced such that a current density at specific areas and the cycle-life characteristics may be deteriorated.

In an implementation, a mixing ratio of the aggregated material of amorphous carbon and the metal nanoparticles may be about 99:1 to 70:30 by weight, e.g., about 99:1 to 75:25 by weight. When the mixing ratio of the aggregated material of amorphous carbon and the metal nanoparticles falls within the ranges, a lithium deposition layer generated by transferring lithium ions released from the positive active material to the negative electrode may be substantial and may be mostly formed between the current collector and the negative electrode layer. Accordingly, the shortcomings such as a short-circuit caused by the deposition of lithium on the surface of the negative electrode layer, a side reaction with the electrolyte, or a crack occurrence on the negative electrode may be effectively prevented.

The amorphous carbon may be, e.g., carbon black, acetylene black, denka black, ketjen black, furnace black, activated carbon, or a combination thereof. An example of the carbon black may be Super P (available from Timcal, Ltd.)

The aggregated material of amorphous carbon may include a secondary particle in which primary particles are aggregated. A particle diameter of the primary particles may be about 20 nm to about 100 nm, and a particle diameter of the secondary particles may be about 1 μm to about 20 μm.

In an implementation, a particle diameter of the primary particles may be, e.g., about 20 nm or more, about 30 nm or more, about 40 nm or more, about 50 nm or more, about 60 nm or more, about 70 nm or more, about 80 nm or more, or about 90 nm or more, and about 100 nm or less, about 90 nm or less, about 80 nm or less, about 70 nm or less, about 60 nm or less, about 50 nm or less, about 40 nm or less, or about 30 nm or less.

In an implementation, a particle diameter of the secondary particle may be, e.g., about 1 μm or more, about 3 μm or more, about 5 μm or more, about 7 μm or more, about 10 μm or more, or about 15 μm or more, and about 20 μm or less, about 15 μm or less, about 10 μm or less, about 7 μm or less, about 5 μm or less, or about 3 μm or less.

The shape of the primary particle may be spherical, oval, plate-shaped, or a combination thereof. In an embodiment, the shape of the primary particle may be spherical, oval, or a combination thereof.

The negative active material according to an embodiment may be prepared by mixing an aggregated material of amorphous carbon including pores therein, in which primary particles are aggregated, to prepare a mixture and heat-treating the mixture at a temperature of a melting point of the metal nanoparticles or higher.

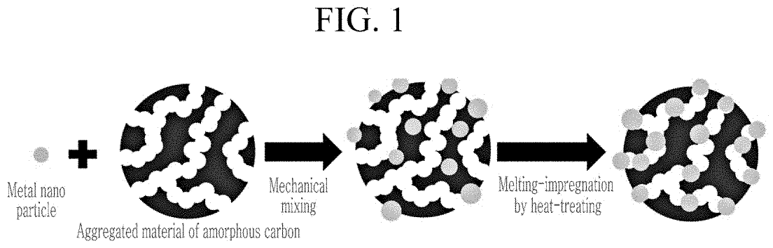

Such a negative active material preparation will be illustrated in more detail, referring to FIG. 1.

Primary particles may be aggregated to prepare a secondary particle that is an aggregated material of amorphous carbon. The aggregation may be performed by a suitable technique, e.g., ball milling or the like. When the secondary particle is prepared by aggregating primary particles, pores may be present inside the primary particles.

The aggregated material of amorphous carbon may be mixed with metal nanoparticles. The mixing process may be performed by a mechanical mixing process such as by using a mortar or a Thinky mixer, or the like. In the mixing, a mixing ratio of the aggregated material of amorphous carbon and the metal nanoparticles may be about 9:1 to 70:30 by weight ratio, or about 99:1 to 75:25 by weight.

The resulting mixture may be heat treated. The heat-treatment may be performed at a temperature sufficient to melt the metal nanoparticles. In an implementation, the heat treatment may be performed at a temperature of a melting point or more of the metal nanoparticles. The heat treatment temperature may be a temperature at which amorphous carbon is not crystallized. In an implementation, the heat treatment temperature may be about 1,000° C. or less.

When the metal nanoparticle is Ag, which has a melting point of about 961.8° C., the heat treatment may be performed at about 961.8° C. or more and about 1,000° C. or less.

When the heat-treatment is performed in the above-described temperature ranges, metal nanoparticles may be melted to fill in the pores present inside of the aggregated material of amorphous carbon.

If the heat-treatment were to be performed at a temperature of less than the melting point of the metal nanoparticles, the metal nanoparticles may not be sufficiently melted. Thus, the filling of the pores in the aggregated material of amorphous carbon may not be sufficient. If the heat-treatment were to be performed at more at a temperature more than about 1,000° C., amorphous carbon may be crystallized, which may cause the intercalation of lithium ions. As a result, the coulomb efficiency and high-rate capability characteristics could be deteriorated.

The heat-treatment may be performed under an inert or relatively inert atmosphere such as a nitrogen atmosphere, an argon atmosphere, or a combination thereof. The heat treatment may be performed for about 10 hours to about 20 hours.

According to the heat treatment, the metal nanoparticles may be melted to fill the pores present inside of the aggregated material of amorphous carbon. Thus, the metal nanoparticles may be substantially and rarely present on the surface of the final negative active material, e.g., the surface of the aggregated material of amorphous carbon.

If the metal nanoparticles and the amorphous carbon were to be mixed at a weight ratio of about 30:70 to 1:99, or of about 25:75 to 1, instead of the weight ratios of about 9:1 to 70:30 or about 99:1 to 75:25 as described above, substantially all of the pores in the aggregated material of amorphous carbon might not be filled with metal nanoparticles. Accordingly, some pores could remain as empty pores.

Another embodiment provides an all solid-state battery including the negative active material.

The all solid-state battery may include a negative electrode including a current collector and a negative electrode layer on one side of the current collector, a positive electrode including a current collector and a positive active material layer on one side of the current collector, and a solid electrolyte between the positive electrode and the negative electrode. The negative electrode layer includes the negative active material according to an embodiment.

An amount of the negative active material in the negative active material layer may be about 60 wt % to about 99 wt % based on the total, 100 wt %, of the negative active material layer, or about 85 wt % to about 99 wt %.

The negative electrode layer may include a butadiene rubber and a cellulose compound. When the binder includes the butadiene rubber and the cellulose compound, the dispersibility of the carbon material and the metal particle may be improved, excellent adherence may be exhibited, and the structural stability may be improved.

The butadiene rubber may include a substituted alkylene structural unit and a structural unit derived from butadiene. In an implementation, the butadiene rubber may be a styrene butadiene rubber (SBR), nitrile butadiene rubber (NBR), acrylate butadiene rubber (ABR), methacrylate butadiene rubber, acrylonitrile-butadiene-styrene rubber (ABS), styrene-butadiene-styrene rubber (SBS), or a combination thereof.

The substituted alkylene structural unit may be derived from a substituted or unsubstituted styrene monomer. Examples of the substituted or unsubstituted styrene monomer may include styrene, α-methylstyrene, 3-methylstyrene, 4-methylstyrene, 2,4-dimethylstyrene, 2,5-dimethyl styrene, 2-methyl-4-chlorostyrene, 2,4,6-trimethylstyrene, cis-(3-methyl styrene, trans-(3-methyl styrene, 4-methyl-α-methylstyrene, 4-fluoro-α-methylstyrene, 4-chloro-α-methylstyrene, 4-bromo-α-methylstyrene, 4-t-butyl styrene, 2-fluorostyrene, 3-fluorostyrene, 4-fluorostyrene, 2,4-difluorostyrene, 2,3,4,5,6-pentafluorostyrene, 2-chlorostyrene, 3-chlorostyrene, 4-chlorostyrene, 2,4-dichlorostyrene, 2,6-dichlorostyrene, octachlorostyrene, 2-bromostyrene, 3-bromostyrene, 4-bromostyrene, 2,4-dibromostyrene, α-bromostyrene, (3-bromostyrene, or a combination thereof.

In an implementation, the substituted alkylene structural unit may be derived from a substituted or unsubstituted nitrile monomer. As examples, the substituted or unsubstituted nitrile monomer may be acrylonitrile, methacrylonitrile, fumaronitrile, α-chloronitrile, α-cyanoethyl acrylonitrile, or a combination thereof.

The structural unit derived from butadiene may be a structural unit derived from a butadiene monomer. An example of the butadiene monomer may be 1,3-butadiene, isoprene, 2,3-dimethyl-1,3-butadiene, 2-ethyl-1,3-butadiene, or a combination thereof.

The cellulose compound may include carboxyl alkyl cellulose, salts thereof, or a combination thereof. The alkyl of the carboxyl alkyl cellulose may be a lower alkyl, such as a C1 to C6 alkyl, a linear alkyl or a branched alkyl. The salts of the cellulose compound may be alkali salts, such as Na, Li, or a combination thereof.

The cellulose compound may impart high viscosity and good applicability and simultaneous improvement of adhesion, thereby preventing or reducing the likelihood of separation of the negative electrode layer from the current collector and providing excellent cycle-life characteristics. The alky of the carboxyl alkyl cellulose may be a lower alkyl. Such a carboxyl alkyl cellulose has high water-solubility such that a water-based electrode may be suitably fabricated.

The butadiene rubber and the cellulose compound may be included in the negative electrode at about a 1:1 to 6:1 weight ratio. A weight ratio of the butadiene rubber may be, based on the cellulose compound, about 1.1 or more, about 1.2 or more, about 1.3 or more, about 1.4 or more, about 1.5 or more, about 1.6 or more, about 1.7 or more, about 1.8 or more, about 1.9 or more, about 2.0 or more, about 2.1 or more, about 2.2 or more, about 2.3 or more, about 2.4 or more, about 2.5 or more, about 2.6 or more, about 2.7 or more, about 2.8 or more, about 2.9 or more, or about 3.0 or more and about 5 or less, about 4.9 or less, about 4.8 or less, about 4.7 or less, about 4.6 or less, about 4.5 or less, about 4.4 or less, about 4.3 or less, about 4.2 or less, about 4.1 or less, about 4.0 or less, about 3.9 or less, about 3.8 or less, about 3.7 or less, about 3.6 or less, about 3.5 or less, about 3.4 or less, about 3.3 or less, about 3.2 or less, about 3.1 or less, or about 3.0 or less. In an implementation, the weight ratio of the butadiene rubber to the cellulose compound may be about 1:1 to 5:1 or about 1:1 to 6:1.

When the butadiene rubber and the cellulose compound are included at the above-described weight ratios, the binder may impart suitable flexibility to the negative electrode layer, thereby inhibiting cracking of the negative electrode layer and increasing the adhesion of the surface of the negative electrode layer. On the other hand, if the butadiene rubber and the cellulose compound were to be included outside of the above-described ranges, the rigidity of the negative electrode could be deteriorated.

An amount of the binder may be about 1 wt % to 40 wt % based on the total, 100 wt %, of the negative electrode layer. The amount of the binder may be, e.g., based on the total, 100 wt % of the negative electrode layer, about 1 wt % to about 15 wt %, or for example, about 1 wt % or more, about 2 wt % or more, about 3 wt % or more, about 4 wt % or more, about 5 wt % or more, about 6 wt % or more, about 7 wt % or more, about 8 wt % or more, about 9 wt % or more, about 10 wt % or more, about 11 wt % or more, about 12 wt % or more, about 13 wt % or more, or about 14 wt % or more, and about 15 wt % or less, about 14 wt % or less, about 13 wt % or less, about 12 wt % or less, about 11 wt % or less, about 10 wt % or less, about 9 wt % or less, about 8 wt % or less, about 7 wt % or less, about 6 wt % or less, about 5 wt % or less, about 4 wt % or less, about 3 wt % or less, or about 2 wt % or less.

When the binder is included in the negative electrode of the all solid-state battery at the above-described weight ranges, the electrical resistance and the adhesion may be improved, and thus the characteristics (battery capacity and power characteristics) of the all solid-state battery may be improved.

The negative electrode may further include the negative active material and the binder, as well as, e.g., additives such as a conductive material, a filler, a dispersing agent, and/or an ionic conductive material. The conductive material in the negative electrode layer, may be, e.g., graphite, carbon black, acetylene black, ketjen black, carbon fiber, metal powder, or the like. As the filler, the dispersing agent, the ionic conductive material included in the negative electrode layer, and suitable materials used for an all solid-state battery, may be used.

The current collector may be, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The current collector may have a foil shape or a sheet shape.

A solid electrolyte included in the solid electrolyte layer may be a sulfide solid electrolyte. In an implementation, the solid electrolyte may be an argyrodite-type sulfide solid electrolyte. The sulfide solid electrolyte may be suitable, as it may exhibit better electrochemical characteristics within wider operation temperature ranges and good ionic conductivity compared to other solid electrolytes such as an oxide solid electrolyte, or the like.

In an implementation, the solid electrolyte may include, e.g., LiₐM_{b}P_{c}S_{d}Aₑ (where a, b, c, d, and e are each independently an integer of 0 or more, and 12 or less, M may be, e.g., Ge, Sn, Si, or a combination thereof, and A may be, e.g., F, Cl, Br, and I). In an implementation, the solid electrolyte may include, e.g., Li₃PS₄, Li₇P₃S₁₁, or Li₆PS₅Cl.

Such a sulfide solid electrolyte may be prepared, e.g., by a fusion quenching process or mechanical milling using starting materials such as Li₂S, P₂S₅, or the like. After the fusion quenching process or mechanical milling, a heat treatment may be performed. The solid electrolyte may be amorphous, crystalline, or a combination thereof.

The sulfide solid electrolyte may be a commercial solid electrolyte.

The solid electrolyte layer may further include a binder. The binder may include, e.g., styrene butadiene rubber, nitrile butadiene rubber, polytetrafluoroethylene, polyvinylidene fluoride, polyethylene, an acrylate polymer, or a combination thereof. In an implementation, the binder may be a suitable material that is used as a binder. The acrylate polymer may be, e.g., poly(butyl acrylate), polyacrylate, polymethacrylate, or a combination thereof.

The solid electrolyte layer may be prepared by adding a solid electrolyte to a binder solution, coating the binder solution/solid electrolyte onto a substrate film, and drying the coating. The binder solution may include isobutylyl isobutyrate, xylene, octyl acetate, or a combination thereof, as a solvent.

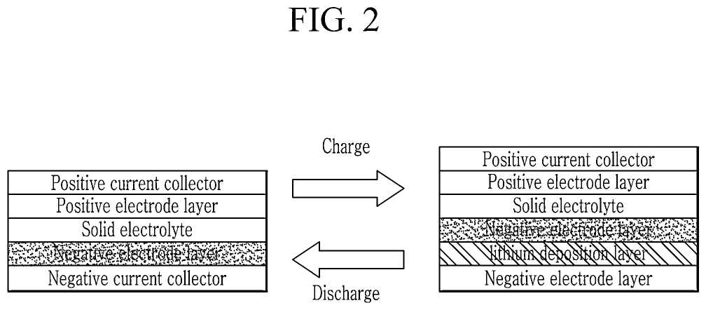

As shown in FIG. 2, when the all solid battery according to an embodiment is charged, lithium ions are released from a positive active material and pass through the solid electrolyte to move to the negative electrode. Thus, the lithium ions may be deposited on the negative current collector to form a lithium deposition layer. In an implementation, the lithium deposition layer may be formed between the negative current collector and the negative active material layer.

The charging may be a formation process which may be performed at about 0.05 C to about 1 C at about 25° C. to about 50° C. once to three times.

The lithium deposition layer may have a thickness of about 10 μm to about 50 μm. In an implementation, the thickness of the lithium deposition layer may be about 10 μm or more, about 20 μm or more, about 30 μm or more, or about 40 μm or more, and about 50 μm or less, about 40 μm or less, about 30 μm or less, or about 20 μm or less. When the thickness of the lithium deposition layer is within the above-described ranges, the lithium may be reversibly deposited during charging and discharging, thereby further improving the cycle-life characteristics.

The positive electrode may include a positive current collector and a positive active material layer positioned on one side of the positive current collector.

The positive active material layer may further include a positive active material. The positive active material may include compounds that reversibly intercalate and deintercalate lithium ions (lithiated intercalation compounds). In an implementation, the positive active material may include one or more composite oxides of a metal selected from cobalt, manganese, nickel, and a combination thereof, and lithium. Specific examples of the positive active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤05); LiₐNi_{1-b-c}Co_{b}B¹_{c}D¹_{α}(0.90≤a≤1.8, 0≤b≤0.5, 0≤c≤0.5, 0≤a≤2); LiₐNi_{1-b-c}Co_{b}B¹_{c}O_{2-α}F¹_{α}(0.90≤a≤1.8, 0≤b≤0.5, 0≤c≤0.5, 0≤α≤2); LiₐNi_{1-b-c}Co_{b}B¹_{c}O_{2-α}F¹₂ (0.90≤a≤1.8, 0≤b≤0.5, 0≤c≤0.5, 0≤α≤2); LiₐNi_{1-b-c}Mn_{b}B¹_{c}D¹_{α}(0.90≤a≤1.8, 0≤b≤0.5, 0≤c≤0.5, 0<α≤2); LiₐNi_{1-b-c}Mn_{b}B¹_{c}O_{2-α}F¹_{α}, (0.90≤a≤1.8, 0≤b≤0.5, 0≤c≤0.5, 0≤α≤2); LiₐNi_{1-b-c}Mn_{b}B¹_{c}O_{2-α}F¹₂ (0.90≤a≤1.8, 0≤b≤0.5, 0≤c≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li _{(3-f)}J₂(PO₄)₃ (0≤f≤2); Li _{(3-f)}Fe₂(PO₄)₃ (0≤f≤2); or LiFePO₄. In the above chemical formulae, A may be selected from Ni, Co, Mn, or a combination thereof; B¹ may be selected from Al, Ni, Co, Mn, Cr, Fe, Mg, Sr, V, a rare earth element, or a combination thereof; D¹ is selected from O, F, S, P, or a combination thereof; E may be selected from Co, Mn, or a combination thereof; F¹ may be selected from F, S, P, or a combination thereof; G may be selected from Al, Cr, Mn, Fe, Mg, La, Ce, Sr, V, or a combination thereof; Q may be selected from Ti, Mo, Mn, or a combination thereof; I¹ may be selected from Cr, V, Fe, Sc, Y, or a combination thereof; and J may be selected from V, Cr, Mn, Co, Ni, Cu, or a combination thereof.

In an implementation, the positive active material may be a lithium transition metal oxide such as LiNiₓCo_{y}Al_{z}O₂(NCA), LiNiₓCo_{y}Mn_{z}O₂(NCM) (herein, 0<x<1, 0<y<1, 0<z<1, x+y+z=1), as examples.

The compounds of the positive active material may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method that does not have an adverse influence on properties of the positive active material by using these elements in the compound. In an implementation, the coating method may include a suitable coating method such as spray coating, dipping, or the like.

The coating layer may include suitable coating materials for a positive active material of an all solid battery. In an implementation, the coating layer may include, e.g., Li₂O—ZrO₂ (LZO), or the like.

When the positive active material includes, e.g., NCA or NCM, and includes nickel, the capacity density of the all solid battery may be further improved, and the elution of metal from the positive active material may be further reduced during the charging. Thus, the all solid battery may exhibit more improved reliability and cycle-life characteristics in the charging state.

Herein, the shape of the positive active material may include, e.g., particle shapes such as a spherical shape and an oval spherical shape. The average particle diameter of the positive active material may be in a suitable range that may be applied to a positive active material of a conventional all solid-state battery. The amount of the positive active material included in the positive active material layer may not be specifically limited, and may be in any range that may be applied to a positive active material of a conventional all solid-state battery.

The positive active material layer may further include a solid electrolyte. The solid electrolyte included in the positive active material layer may be the aforementioned solid electrolyte, and may be the same as or different from the solid electrolyte included in the solid electrolyte layer. The solid electrolyte may be included in the positive active material layer an amount of about 10 wt % to about 30 wt % based on the total weight of the positive active material layer.

The positive current collector may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

The positive active material layer may further include additives such as a conductive material, a binder, a filler, a dispersing agent, an ion conductive material, or the like, in addition to the aforementioned positive active material and the solid electrolyte.

The filler, the dispersing agent, and the ion conductive material, which are included in the positive active material layer, may be the same as the additives included in the negative active material layer. Herein an amount of the conductive material may be about 1 wt % to about 10 wt % with reference to the total of 100 wt % of the positive active material layer.

The binder, which may be included in the positive active material, may include, e.g., a styrene butadiene rubber (SBR), polytetrafluoroethylene, polyvinylidene fluoride, polyethylene, or the like.

The thickness of the positive active material layer may be about 90 μm to about 200 In an implementation, the thickness of the positive active material layer may be about 90 μm or more, about 100 μm or more, about 110 μm or more, about 120 μm or more, about 130 μm or more, about 140 μm or more, about 150 μm or more, about 160 μm or more, about 170 μm or more, about 180 μm or more, or about 190 μm or more, and about 200 μm or less, about 190 μm or less, about 180 μm or less, about 170 μm or less, about 160 μm or less, about 150 μm or less, about 140 μm or less, about 130 μm or less, about 120 μm or less, or about 110 μm or less. As described above, the thickness of the positive active material layer may be greater than the thickness of the negative active material layer, and thus, the capacity of the positive electrode may be larger than the capacity of the negative electrode.

The positive electrode may be prepared by forming a positive active material layer on a positive current collector using a dry-coating or wet-coating process.

In an implementation, the all solid-state battery may further include a buffer material for buffering a thickness variation that may be a result of charging and discharging. The buffer material may be between the negative electrode and the positive electrode, or between the one assembly and another assembly of a battery in which at least one electrode assembly is stacked.

The buffer material may include materials having elasticity recovery of about 50% or more and insulating properties. In an implementation, the buffer material may be or include silicon rubber, acryl rubber, fluorine rubber, nylon, synthetic rubber, or a combination thereof. The buffer material may be in a form of a polymer sheet.

FIG. 2 schematically shows states of the all solid-state battery during charging and discharging. The all solid-state battery as shown includes: a positive electrode including a positive current collector and a positive electrode layer; a negative electrode including a negative current collector and a negative electrode layer; and a solid electrolyte between the positive electrode and the negative electrode. When the all solid-state battery 100 is charged, lithium ions are released from a positive active material and deposited on the negative current collector so as to be positioned between the current collector and the negative electrode layer.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

(1) Preparation of Negative Electrode

An aggregated material of carbon black in which primary particles with an average particle diameter of 30 nm were aggregated to have pores inside, was mechanically mixed with Ag with an average size of 60 nm at a 75:25 weight ratio using a mortar. The mixture was heat-treated at 980° C. under a nitrogen atmosphere for 12 hours to prepare a negative active material.

The negative active material, styrene butadiene rubber, and sodium carboxymethyl cellulose were mixed at 100:6:3 by weight ratio in a water solvent to prepare a negative active material slurry.

The prepared slurry was coated on a stainless steel foil current collector and vacuum-dried at 80° C. to prepare a negative electrode having a negative electrode layer with a 12 μm thickness and a current collector with a 10 μm thickness. Herein, the thickness of the negative electrode layer was 12 μm.

(2) Preparation of Solid Electrolyte Layer

An argyrodite-type solid electrolyte Li₆PS₅C1, and an isobutylyl isobutyrate binder solution (solid amount: 50 wt %) combined with an acrylate polymer, poly(butyl acrylate), were mixed. The mixing ratio of the solid electrolyte and the binder was 98.7:1.3 by weight ratio.

The mixing was performed by using a Thinky mixer. 2 mm zirconia balls were added to the obtained mixture and the obtained mixture was repeatedly mixed with the Thinky mixer to prepare a slurry. The slurry was cast onto a polytetrafluoroethylene release film and dried at room temperature to prepare a solid electrolyte layer with a thickness of 100 μm.

(3) Preparation of Positive Electrode

100 parts by weight of the LZO (Li-doped zinc oxide: Li₂O—ZrO₂)—coated positive active material LiNi_{0.9}Co_{0.05}Mn_{0.05}O₂, 17.6 parts by weight of an argyrodite-type solid electrolyte Li₆PS₅Cl, 3.53 parts by weight of a carbon nanofiber conductive material, and 1.76 parts by weight a polytetrafluoroethylene binder were mixed in an N-methyl pyrrolidone to prepare a mixture. In the mixture, the weight ratio of the positive active material, the solid electrolyte, the conductive material and the binder was 85:15:3:1.5.

The mixture was coated onto an aluminum foil current collector and vacuum-dried at 45° C. to prepare a positive electrode having a positive active material layer with a 160 μm thickness and a current collector with a 10 μm thickness. As described above, the positive active material layer had a thickness of 160 μm.

(4) Preparation of all Solid-State Full Cell

The resulting negative electrode, the solid electrolyte and the positive electrode as a counter electrode were sequentially stacked and were pressurized at a pressure of 4 Nm to fabricate a full cell.

### Comparative Example 1

An aggregated material of carbon black in which primary particles with an average particle diameter of 30 nm were aggregated to have pores therein, was mechanically mixed with Ag with an average size of 60 nm at a 75:25 weight ratio using a mortar, thereby preparing a negative active material.

A negative electrode and a full cell were fabricated by the same procedure as in Example 1, except that the negative active material was used.

Experimental Example 1) SEM image

The SEM images for the negative active materials of Example 1 and

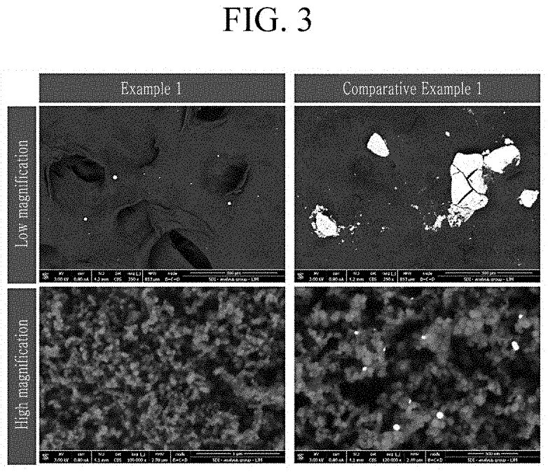

Comparative Example 1 are shown in FIG. 3 with a low magnification (350× magnification) and high magnification (100,000 magnification).

As shown in FIG. 3, in the negative active material according to Example 1, silver was melted and distributed in the pores of the amorphous carbon, and thus, silver was rarely detected on the surface. On the other hand, in the negative active material of Comparative Example 1, silver was detected on the surface of the negative active material.

(Experimental Example 2) Evaluation of cycle-life characteristic and coulomb efficiency

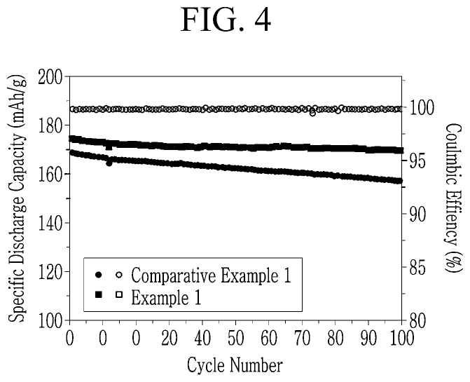

The all solid-state cells of Example 1 and Comparative Example 1 were charged and discharged at 0.33 C 100 times. The discharge capacity at each cycle was measured. The results are shown in FIG. 4. Furthermore, the coulomb efficiency, which is the ratio of the discharge capacity to the charge capacity, was measured. The results are shown in FIG. 4.

In FIG. 4, the dots with filled insides indicate discharge capacity and the dots with empty insides indicate coulomb efficiency.

As shown in FIG. 4, the all solid-state cell of Example 1 exhibited slightly higher coulomb efficiency compared to Comparative Example 1, but exhibited higher discharge capacity than Comparative Example 1 after 100 cycles, indicating high cycle-life characteristics.

Experimental Example 3) Evaluation of Rate-Capability Characteristic

The all solid-state cells of Example 1 and Comparative Example 1 were charged and discharged at 0.1 C once, at 0.33 C once and at 1 C once. The discharge capacity at each C-rate was measured. The results are shown in Table 1.

TABLE 1

| | | Comparative Example 1 | Example 1 |
|---|---|---|---|
| 0.1 C | (mAh/g) | 198.4 | 201.0 |
| 0.33 C | (mAh/g) | 184.5 | 187.7 |
| 1 C | (mAh/g) | 147.7 | 167.7 |

As shown in Table 1, the all solid-state cell of Example 1 exhibited better rate capability, particularly, high-rate capability than the all solid stat cell of Comparative Example 1.

By way of summation and review, as a method of increasing the energy density of an all solid-state battery, a lithium metal has been used as a negative electrode. However, the use of lithium metal may cause the expansion of volume of lithium and may irreversibly generate dendrites during charging and discharging.

In order to address such issues, there have been attempts to prepare a negative electrode from a deposition of lithium on a negative current collector without using lithium metal by itself. However, this approach has been found to severely result in low power characteristics and short-circuits.

Embodiments provide an all solid-state cell that exhibits high coulomb efficiency and high cap cycle-life characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material for an all solid-state battery, the negative active material comprising:
an aggregated material of amorphous carbon having pores therein and in which primary particles are aggregated; and
metal nanoparticles filling in the pores.

2. The negative active material for an all solid-state battery as claimed in claim 1, wherein the metal nanoparticles include Ag, Au, Sn, Zn, Al, Mg, Ge, Cu, In, Ni, Bi, Pt, Pd, or a combination thereof.

3. The negative active material for an all solid-state battery as claimed in claim 1, wherein the metal nanoparticles have an average size of about 5 nm to about 80 nm.

4. The negative active material for an all solid-state battery as claimed in claim 1, wherein a mixing ratio of the aggregated material of amorphous carbon and the metal nanoparticles is about 99:1 to 70:30 by weight.

5. The negative active material for an all solid-state battery as claimed in claim 1, wherein a mixing ratio of the aggregated material of amorphous carbon and the metal nanoparticles is about 99:1 to 75:25 by weight.

6. The negative active material for an all solid-state battery as claimed in claim 1, wherein:
the negative active material is an active material prepared by mixing an aggregated material of amorphous carbon having pores inside and in which primary particles are aggregated with metal nanoparticles to prepare a mixture; and
heat-treating the mixture at a temperature of a melting point of the metal nanoparticles or higher.

7. The negative active material for an all solid-state battery as claimed in claim 6, wherein the heat treatment is performed at a temperature of about 1,000° C. or less.

8. An all solid-state battery, comprising:
a negative electrode including a current collector and a negative electrode layer on one side of the current collector;
a positive electrode; and
a solid electrolyte between the negative electrode and the positive electrode,
wherein the negative electrode layer includes the negative active material as claimed in claim 1.

9. The all solid-state battery as claimed in claim 8, wherein the solid electrolyte is a sulfide solid electrolyte.

10. The all solid-state battery as claimed in claim 9, wherein the solid electrolyte is LiₐM_{b}P_{c}S_{d}Aₑ, in which a, b, c, d and e are each independently 0 or more and 12 or less, M is Ge, Sn, Si, or a combination thereof, and A is F, Cl, Br, or I.

11. The all solid-state battery as claimed in claim 8, wherein the negative electrode further includes a lithium deposition layer, after charging.

12. The all solid-state battery as claimed in claim 11, wherein the lithium deposition layer has a thickness of about 10 μm to about 50 μm.
